(19) United States
(12) Patent Application Publication
(10) Pub. No.: US 2024/0295282 A1
(43) Pub. Date: Sep. 5, 2024

(54) Heated Hose With Angled Connector And Plug-In Coupling

(71) Applicant: Robatech AG, Muri (CH)

(72) Inventors: Michael Hürlimann, Bremgarten (CH); Claudio Hofer, Hagendorn (CH); Stephan Knecht, Beinwil am See (CH)

(73) Assignee: Robatech AG, Muri (CH)

(21) Appl. No.: 18/593,231

(22) Filed: Mar. 1, 2024

(30) Foreign Application Priority Data
Mar. 3, 2023 (EP) 23 159 967.1

(51) Int. Cl. F16L 43/02; B05C 5/00; B05C 5/02; F16L 37/084; F16L 53/35

(52) U.S. Cl. CPC F16L 43/02; B05C 5/001; B05C 5/0229; F16L 37/084; F16L 53/35

(57) ABSTRACT

A heated hose for passage of a free-flowing medium, for example for the passage of a hot-melt adhesive. The heated hose has an angled attachment piece, wherein the attachment piece has a first limb and, angled with respect to the first limb, a second limb, wherein the attachment piece has a through-channel which runs through the limbs to allow the free-flowing medium to pass through the attachment piece, and wherein the attachment piece has a coupling connector for producing a fluidic connection between the heated hose and an external apparatus, by coupling the external apparatus along a coupling axis of the coupling connector.

### FIELD OF THE INVENTION

The present invention relates to a heated hose for the passage of a free-flowing medium, for example for the passage of a hot-melt adhesive. The present invention further relates to an application system having such a heated hose and to a method for producing the heated hose. In a further aspect, the present invention relates to a plug coupling system.

### BACKGROUND OF THE INVENTION AND RELATED ART

Many different industries use hot-melting, free-flowing media, for example hot-melt adhesives, to connect parts to one another. Hot-melt adhesives are used, for example, in the production of packaging means, such as folding boxes or trays, or in the graphics industry, the construction industry and wood industry, and also for the production of mattresses. Before processing, such free-flowing media generally have to be transferred from a solid state into a liquid state or pasty state by the action of heat. The liquefied free-flowing medium is then supplied via a heatable heated hose to an application device which serves for applying the free-flowing medium to a substrate. The application device can be, for example, a hand spray gun or an application head, in particular an application head provided with a dosing valve.

The heated hose serves in particular to join the application device to a melter. The melter serves to melt the hot melt adhesive, which is solid at room temperature and which is present, for example, in the form of granules. With the heated hose, the liquefied hot-melt adhesive is then conveyed to an application device, for example an application head, wherein, by means of the application device, the adhesive is applied to the substrate that is to be glued. The heated hose serves in particular to keep the free-flowing medium introduced into the heated hose within a defined temperature range and/or to heat the medium in the heated hose to a defined setpoint temperature or a defined setpoint temperature range.

The heated hose thus serves as a heated and flexible means of transport for the free-flowing medium. By virtue of its flexibility, the heated hose can be routed substantially freely between the components that are to be connected, for example between a melter and an application device.

A heated hose generally has an attachment piece, wherein the attachment piece serves to couple the heated hose to the external component, for example to the application device or to the melter, for the purpose of producing a fluidic connection. Such attachment pieces are generally straight, and therefore, in the case of a straight heated hose, the attachment piece or its coupling axis is in alignment with the heated hose. A heated hose of this kind is known, for example, from US 2003/007789 A1 and from EP 0 080 811 A1.

A heated hose is known from U.S. Pat. No. 4,524,887, which discloses:

A heated hose for the passage of a free-flowing medium, having:
a flexible heated-hose body having:
   a high-pressure hose, wherein the high-pressure hose has a hose core, for the passage of the free-flowing medium, and a reinforcement surrounding the hose core,
   at least one heat conductor for heating the medium flowing in the high-pressure hose,
   a thermal insulation layer made of a thermally insulating material and surrounding the high-pressure hose and the at least one heat conductor,
   an outer sleeve surrounding the thermal insulation layer,
an attachment piece connected to the high-pressure hose, wherein the attachment piece has a through-channel, which allows the free-flowing medium to pass through the attachment piece, and a coupling connector for producing a fluidic connection between the heated hose and an external apparatus, by coupling the external apparatus along a coupling axis of the coupling connector,
an end cap, wherein the end cap covers an end portion of the flexible heated-hose body.

The coupling connector disclosed in U.S. Pat. No. 4,524,887 is formed at an outlet end of the heated hose. The coupling connector is a terminal screw connector of the high-pressure hose, of which the coupling axis, in the case of a straight high-pressure hose or a straight heated hose, is designed in the direction of longitudinal extent of the heated hose. Relative to the attachment piece, the outgoing direction of the heated hose from the attachment piece is thus identical with the coupling axis of the attachment piece. Since the end cap is generally more dimensionally stable or stiffer than the flexible heated-hose body, it can happen that, on account of space requirements, the heated hose cannot be coupled directly to the external apparatus, possibly since there is not enough space in the coupling direction and/or the outgoing direction of the heated hose, and since the flexibility of the heated hose is not sufficient to attach the heated hose to the external apparatus. Moreover, small bending radii of the heated hose, which would possibly be necessary on account of the limited space, are considered to be a disadvantage. To tackle this problem, it is known, for example from U.S. Pat. No. 4,524,887, to use angled intermediate parts. A disadvantage of angled intermediate parts is that these intermediate parts are then exposed and not insulated, which may lead to the free-flowing medium cooling in this region. If required, the intermediate parts would then have to be provided with separate insulation or even with a separate heating device.

### OBJECTS OF THE INVENTION

There is therefore a need for a heated hose that overcomes the aforementioned disadvantages. There is also a need for a flexible application system. Furthermore, there is a need for a simple method of production of the heated hose. These objectives are achieved by a heated hose having the features disclosed herein. These objectives are further achieved by a method according to the present invention and by an application system according to the present invention.

### SUMMARY OF THE INVENTION

In the heated hose, provision is made that the attachment piece is designed as an angled attachment piece which has a first limb and, angled with respect to the first limb, a second limb, wherein the attachment piece has a through-channel which runs through the limbs in order to allow the free-flowing medium to pass through the attachment piece, wherein the first limb is connected to the high-pressure hose, wherein the second limb is formed at least partially in a region surrounded by the end cap, and wherein the coupling connector is formed in the region of the second limb.

In this way, particularly good thermal insulation in the region of the attachment piece and an angled outgoing direction of the heated hose are achieved without the use of separate intermediate parts. This is to be considered advantageous particularly when the aim is to avoid cooling of the free-flowing medium in the region between an application head and the heated hose, so as to achieve particularly good and clean application of the free-flowing medium. Cooling of the medium is to be considered a disadvantage particularly in the case of unheated application heads. However, even in the case of heated application heads, it can happen that the heating power is not sufficient to heat the cooled medium back to the desired processing temperature. Especially after a prolonged interruption in operations or after switching on of a cold application system, inadequately insulated, hence exposed, transitions must be considered a disadvantage. This is particularly problematic since the temperature of the medium is generally not measured directly, instead only the temperature of the application head or of a region of the application head is measured.

The external apparatus is, for example, an application head which is supplied with free-flowing medium by means of the heated hose. However, the external apparatus can also be an apparatus for melting the adhesive, with this molten adhesive then being conveyed into the heated hose.

It is considered advantageous if the coupling connector forms a constituent part of a plug coupling, and the plug coupling preferably has as constituent parts a plug and a socket, wherein the coupling connector forms the plug of the plug coupling. A plug coupling facilitates the connection of heated hose and external apparatus.

Preferably, the coupling connector is arranged outside the end cap and thus protrudes from the end cap. This facilitates the production of the connection. Particularly in the case of a plug coupling, this design has the advantage that the exposed region, namely the plug, is at least partially arranged in the external apparatus, which is generally heated. In this way, the heated hose can be brought with its end cap particularly close to the external apparatus, which has an advantageous effect on the thermal insulation in the coupling region.

The attachment piece is advantageously designed in one piece. The attachment piece is preferably stiff.

It is considered advantageous if the connection between the first limb and the high-pressure hose is designed as a screw connection, of which the screw axis corresponds to the longitudinal axis of the first limb. During the production of the heated hose, in particular when winding the heat conductors and/or winding the thermal insulation layer around the high-pressure hose, which is generally acquired as a prefabricated part, an angled attachment piece, which would disrupt the rotational symmetry, would be an impediment. By means of the screw connection, the attachment piece can, if required, be mounted particularly easily after the production of the heated-hose body. The end cap, for example in the form of two heated-hose shells, is then mounted. Despite the inherently releasable connection between the attachment piece and the high-pressure hose, the end cap prevents the connection, for example a union nut of the connection, from being undone. A non-releasable union between the high-pressure hose and the attachment piece is thus formed, such that the angled attachment piece forms an integral constituent part of the heated hose.

However, it is also conceivable that the angled attachment piece and the high-pressure hose are connected to each other not via a releasable connection, but via a non-releasable connection, for example by being pressed together.

In a preferred embodiment, provision is made that the end cap is in engagement with a groove formed on an outer face of the second limb. In this way, a stable connection between the attachment piece and the end cap is formed. Moreover, the end cap is held in position through the interaction with the groove.

Preferably, the end cap is angled in a manner corresponding to the angled attachment piece. In this way, the installation space for the end cap is kept as small as possible. Moreover, it is immediately evident to the user where the coupling face or the coupling connector is located. This simplifies handling.

The end cap preferably has two half-shells. The design of the end cap with two half-shells makes assembly particularly simple. In particular, the heated-hose body can first be produced or made available. Then the attachment piece can be connected to the high-pressure hose. Thereafter, the two half-shells can be assembled in order to form the end cap. It is considered particularly advantageous if the half-shells are connected releasably to each other, for example clipped together or screwed together.

In a particularly preferred embodiment, provision is made that the end cap is dimensionally stable, hence less flexible than the heated-hose body. This makes it easier to couple the heated hose to the external apparatus, since the dimensionally stable end cap enables precise guiding of the heated hose to the coupling region of the external apparatus. Moreover, in the case of a coupling designed as a plug coupling between the external apparatus and the heated hose, it is not necessary to have a lot of installation space available in the region of the coupling. Rather, the end cap can also be grasped and handled in a region of the end cap directed away from the coupling connector. However, since the end cap is dimensionally stable, precise guiding of the coupling connector is possible during coupling and uncoupling. Moreover, a dimensionally stable end cap has the advantage that the mechanical loading of the components of the heated hose that are located in the region of the end portion is reduced.

It is considered advantageous if the material of the end cap is resistant to temperature and to impact. Preferably, the material is temperature-resistant up to a temperature of at least about 150° C., preferably at least about 200° C., particularly preferably at least about 250° C. It is considered particularly advantageous if the end cap is made from a stiff material. Preferably, the end cap and/or the half-shells consist(s) of polyphenylene sulfide (PPS), in particular glass-fiber-reinforced PPS, or of glass-fiber reinforced liquid crystal polymer (LCP). However, other materials are also conceivable for the end cap, in particular glass-fiber-reinforced, temperature-resistant plastics.

It is considered particularly advantageous if the thermal insulation layer encloses at least a partial region of the first limb. Preferably, the thermal insulation layer extends over the angle range of the attachment piece, thus partially over the second limb.

In a preferred embodiment, provision is made that the connecting portion and/or the thermal insulation layer protrudes at one end with respect to the outer sleeve. Therefore, the outer sleeve does not necessarily have to extend completely over the end portion. Rather, it is considered advantageous if the outer sleeve extends only partially in the region of the end portion.

It is considered advantageous if the outer sleeve extends at least into the region enclosed by the end cap.

In a preferred embodiment, provision is made that the through-channel of the attachment piece is formed by a first bore extending along a longitudinal axis of the first limb of the attachment piece and by a second bore extending along a longitudinal axis of the second limb of the attachment piece.

Preferably, the attachment piece is made of a metal or of a metal alloy.

In a preferred embodiment, provision is made that an angle between the first limb and the second limb of the attachment piece measures between about 40° and about 50°, preferably about 45°.

Preferably, the end cap and/or the half-shells are injection molded parts. However, the end cap can also be cast onto the heated-hose body.

The heated hose can be heated electrically in particular. Preferably, the heated hose is configured to keep the free-flowing medium at an operating temperature of about 20° C. to about 250° C. Preferably, the heated hose is stable under pressure up to an operating pressure of the free-flowing medium of at least about 100 bar, preferably of at least about 300 bar, particularly of up to about 400 bar. A hose length preferably measures from about 0.6 m to about 10 m. The hose core of the high-pressure hose, serving to convey the free-flowing medium, preferably has an internal diameter of about 2 mm to about 40 mm, in particular of about 6 mm to about 40 mm, preferably of about 6 mm to about 25 mm. The heated hose preferably has an external diameter of about 20 mm to about 70 mm, in particular of about 27 mm to about 57 mm. The end cap preferably has a longitudinal extent of about 100 mm to about 300 mm.

In the state when coupled to the external apparatus, the heated hose is preferably rotatable about the axis of the coupling connector. In this way, the heated hose can be easily modified in terms of its outgoing direction with respect to the external apparatus. It is considered particularly advantageous if the attachment piece is rotatable only in the pressure-free state of the free-flowing medium.

The heated hose with an angled attachment piece, and with a coupling connector designed as a constituent part of a rotatable plug coupling, has the advantage that the heated hose can be mounted and operated in different arrangements and outgoing directions without additional parts and without tools. This makes it possible to adapt the glue application device optimally to the product to be glued and optimally to the installation conditions in a production facility, without different variants or intermediate parts having to be used.

The method according to the present invention is a method for producing the heated hose according to the present invention or one of the above-described embodiments of the heated hose. The method has the following method steps:
a) producing or providing a flexible heated-hose body, the flexible heated-hose body having:
   a high-pressure hose, wherein the high-pressure hose has a hose core, for the passage of the free-flowing medium, and a reinforcement surrounding the hose core,
   at least one heat conductor for heating the medium flowing in the high-pressure hose,
   a thermal insulation layer made of a thermally insulating material and surrounding the high-pressure hose and the at least one heat conductor,
   an outer sleeve surrounding the thermal insulation layer,
b) providing an angled attachment piece, wherein the attachment piece has a first limb and, angled with respect to the first limb, a second limb, wherein the attachment piece has a through-channel which runs through the limbs in order to allow the free-flowing medium to pass through the attachment piece, wherein the first limb is releasably connectable to the high-pressure hose, wherein the second limb has a coupling connector for producing a fluidic connection between the heated hose and an external apparatus, by coupling the external apparatus along a coupling axis of the coupling connector,
c) producing the releasable connection between the high-pressure hose and the first limb of the attachment piece, wherein method step c) takes place after method steps a) and b),
d) arranging an end cap on an end portion of the heated-hose body, in such a way that the end cap covers the end portion of the flexible heated-hose body, wherein the second limb of the attachment piece is formed at least partially in a region enclosed by the end cap, wherein method step d) takes place after method step c).

The advantage of the disclosed method is that a conventional production process for the heated-hose body can be retained, since the angled attachment piece is only connected subsequently to the high-pressure hose. During winding of the heated hoses, an angled end or attachment piece would get in the way. In the present case, the attachment piece is mounted only after the winding process. The end cap, for example in the form of heated-hose shells, is then mounted. The attachment piece is partially covered and insulated by the end cap.

Preferably, the heat conductor is wound in a helical configuration around the heated-hose body.

The attachment piece is preferably screwed onto the high-pressure hose.

As has already been stated, the heated hose according to the present invention affords particular advantages in use with external apparatuses, in particular with an application head, since the heated hose easily allows the components to be arranged in an optimized manner with regard to structural space. The application system according to the present invention accordingly has the heated hose according to the present invention or one of the above-described embodiments of the heated hose. Moreover, the application system has an application head for dispensing the free-flowing medium, wherein the application head has a coupling socket corresponding to the coupling connector, wherein the coupling connector and the coupling socket form a plug coupling. The coupling of the constituent parts of the plug coupling, namely the insertion of the coupling connector into the coupling socket, takes place along the coupling axis of the coupling connector. The application head has a dosing valve, so that the free-flowing medium supplied to the application device via the heated hose can be selectively dispensed from a dispensing opening of the application head, wherein the dosing valve has a valve rod, wherein the valve rod is displaceable, along a longitudinal axis of the valve rod, between a closed position, in which the valve rod closes the dispensing opening of the application head, and an open position, in which the valve rod opens the dispensing opening of the application head, wherein the coupling axis and the longitudinal axis of the valve rod are angled relative to each other, wherein the coupling connector is rotatable in the coupling socket about the coupling axis. With this design, different outgoing directions of the heated hose from the application head can be obtained by rotating the heated hose about the coupling axis. Moreover, the heated hose can be easily and quickly separated from the application head without tools.

In connection with such a plug coupling between attachment piece and application head, it is considered advantageous if the attachment piece is secured in the coupling socket. During operation, the free-flowing medium is typically at high pressure, for example about 100 bar to about 300 bar. The attachment piece can be secured in the coupling socket in the coupled position via a closure slide that is displaceable transverse to the direction of insertion. In a preferred embodiment, the closure slide has two securing limbs. The coupling socket has two through-openings for the insertion of the securing limbs, wherein the through-openings run through the coupling socket in such a way that the securing limbs are insertable into the through-openings from two opposite sides. On its outer face, the coupling connector has a circumferential securing groove, wherein the through-openings are aligned with the securing groove in the coupled position. Thus, the limbs can be pushed through the through-openings into the securing groove and thus brought into engagement with the latter in order to obtain a securing position. In the securing position of the closure slide, the securing limbs are accordingly pushed through the through-openings into the circumferential securing groove, so as to secure the attachment piece in the coupling socket. To release the securing, the limbs and the securing groove are disengaged through displacement or withdrawal of the closure slide. In this open position of the closure slide, the heated hose can be uncoupled from the application head. In the securing position of the closure slide, the latter prevents the attachment piece from being pushed out and thus prevents release of the plug coupling on account of pressure forces. Moreover, the attachment piece is thereby secured against unintentional removal.

By virtue of the fact that the securing limbs of the closure slide are insertable into the through-openings from two opposite sides, the closure slide can be mounted at two different positions, such that the closure slide can for example can be pulled out either to the left or to the right in relation to the application head. The installation position of the closure slide can thus be easily changed, for example in order to adapt to the available space and for accessibility to the application head.

It is considered advantageous if the closure slide is held captively in the coupling socket by a securing cap plugged onto the coupling socket. The securing cap also insulates the coupling socket from the outside, thereby reducing injuries to the operator on account of the hot attachment socket and heat losses in the region of the attachment socket. The securing cap preferably has a cover portion, with an opening for the attachment piece, and a jacket portion adjoining the cover portion, wherein the securing limbs pass through the jacket portion, wherein a displacement of the closure slide from the securing position and past an open position, in which the securing limbs and the securing groove are disengaged, is prevented by the respective securing limb having a stop interacting with the jacket portion. Thus, with the end cap plugged on, the closure slide cannot be pulled out completely and is thus held captively on the application head and yet can be transferred from the securing position to the open position.

Preferably, the securing cap can be plugged onto the coupling socket in two different rotational positions, so that the same securing cap can be used for both directions of insertion or positions of the closure slide.

Preferably, the securing cap is latched onto the coupling socket or onto a cover of the application head.

Preferably, the angle between the longitudinal axis of the valve rod and the coupling axis corresponds to the angle between the limbs of the attachment piece, in particular about 45°. Thus, the same components can be used to easily obtain an outgoing direction of the heated hose of about 0° to the longitudinal axis of the valve rod and an outgoing direction of the heated hose of about 90° to the longitudinal axis of the valve rod. To do so, the heated hose simply has to be rotated through 180° about the coupling axis in order to change from an outgoing direction of about 0° to an outgoing direction of about 90°.

In a further aspect, the present invention relates to a plug coupling system. The plug coupling system can be used in particular in connection with the aforementioned heated hose and in the aforementioned application system.

During operation, a free-flowing hot medium, for example hot adhesive, flows in a heated hose. Generally, this adhesive is also at a relatively high pressure, for example about 42 bar. Plug coupling systems are often used to connect the heated hose to a consumer of the free-flowing medium, for example an application head, or to a generator of the free-flowing medium, for example a melter, in particular a melter with an integrated pump, for the purpose of producing a fluidic connection between the heated hose and the consumer and/or generator.

Since the medium conveyed in the heated hose is under pressure, release of the plug coupling can result in pressurized medium escaping in an uncontrolled manner in the region of the plug coupling. Here, on account of the abrupt pressure release, there is a danger of uncontrolled escape of hot medium, for example in spray form. There is therefore a danger of injury to persons, and the plug coupling system, surrounding parts and equipment may be contaminated, and there may be a loss of free-flowing medium with corresponding economic consequences.

There is therefore a need for a plug coupling system in which release of the plug coupling is prevented or at least made difficult in the presence of pressurized medium.

This object is achieved by the plug coupling system described below and by the embodiments thereof.

### Aspect 1:

A plug coupling system for producing a fluidic connection to a heated hose (3), wherein the plug coupling system has:
a heated hose (3) for the passage of a free-flowing medium, wherein the heated hose has an attachment piece (16) for producing a fluidic connection to the heated hose (3), wherein the attachment piece (16) has a through-channel (17), allowing the free-flowing medium to pass through the attachment piece (16), and a coupling connector (20), wherein the coupling connector (20) has a circumferential securing groove (32) on its outer face,
a coupling socket (23) corresponding to the coupling connector (20), wherein the coupling connector (20) and the coupling socket (23) form a plug coupling, wherein the coupling connector (20) is insertable into the coupling socket (23), along a coupling axis (L2) of the coupling connector (20), in order to produce a coupled arrangement,
a closure slide (29) for securing the attachment piece (16) in the coupling socket (23) in the coupled arrangement, wherein the closure slide (29) has two securing limbs (30), wherein the respective securing limb (30) has a latching recess (37) on its inner face directed toward the other securing limb (30), wherein the latching recesses (37) result in the formation, between the securing limbs (30), of a receiving region (43) which is adapted to the coupling connector (20) and has a constriction (38), wherein the coupling connector (20) overcomes the constriction (38) by means of the securing limbs (30) deflecting away from each other, wherein the coupling socket (23) has two through-openings (31) for the securing limbs (30), wherein the through-openings (31) are aligned with the securing groove (32) in the coupled arrangement, such that, in the coupled arrangement, the securing limbs (30) are insertable through the through-openings (31) into the circumferential securing groove (32), in order to produce a securing position, wherein, in the securing position, the coupling connector (20) is received with latching engagement in the receiving region (43) and the attachment piece (16) and the coupling socket (23) bear on each other along the coupling axis (L2), via the securing limbs (30), in order to secure the attachment piece (16) in the coupling socket (23), wherein the through-openings (31) and the securing limbs (30) are designed in such a way that, in the securing position, a deflection of the securing limbs (30) away from each other causes a displacement of the attachment piece (16) along the coupling axis (L2) into the coupling socket (23),
   or wherein the plug coupling system has:
a heated hose (3) for the passage of a free-flowing medium, wherein the heated hose (3) has a coupling socket (23) for producing a fluidic connection to the heated hose (3),
an attachment piece (16), wherein the attachment piece (16) has a through-channel (17), allowing the free-flowing medium to pass through the attachment piece (16), and a coupling connector (20) corresponding to the coupling socket (23), wherein the coupling connector (20) and the coupling socket (23) form a plug coupling, wherein the coupling connector (20) is insertable into the coupling socket (23), along a coupling axis (L2) of the coupling connector (20), in order to produce a coupled arrangement, wherein the coupling connector (20) has a circumferential securing groove (32) on its outer face,
a closure slide (29) for securing the attachment piece (16) in the coupling socket (23) in the coupled arrangement, wherein the closure slide (29) has two securing limbs (30), wherein the respective securing limb (30) has a latching recess (37) on its inner face directed toward the other securing limb (30), wherein the latching recesses (37) result in the formation, between the securing limbs (30), of a receiving region (43) which is adapted to the coupling connector (20) and has a constriction (38), wherein the coupling connector (20) overcomes the constriction (38) by means of the securing limbs (30) deflecting away from each other, wherein the coupling socket (23) has two through-openings (31) for the securing limbs (30), wherein the through-openings (31) are aligned with the securing groove (32) in the coupled arrangement, such that, in the coupled arrangement, the securing limbs (30) are insertable through the through-openings (31) into the circumferential securing groove (32), in order to produce a securing position, wherein, in the securing position, the coupling connector (20) is received with latching engagement in the receiving region (43) and the attachment piece (16) and the coupling socket (23) bear on each other along the coupling axis (L2), via the securing limbs (30), in order to secure the attachment piece (16) in the coupling socket (23), wherein the through-openings (31) and the securing limbs (30) are designed in such a way that, in the securing position, a deflection of the securing limbs (30) away from each other causes a displacement of the attachment piece (16) along the coupling axis (L2) into the coupling socket (23).

The two alternatives are largely identical in terms of their design, mode of action and kinematics, the difference being that, in the first alternative, the heated hose 3 has the attachment piece 16 and, in the second alternative, the heated hose 3 has the coupling socket 23. Therefore, the following observations apply both to the first alternative and to the second alternative, unless stated otherwise.

As long as the closure slide 29 is located in the securing position, the coupling socket 23 and the coupling connector 20 cannot be separated from each other. The closure slide 29 thus secures the coupled arrangement. To release the coupling socket 23 and the coupling connector 20 from each other, it is necessary to transfer the closure slide 29 to an open position, in which the attachment piece 16 does not bear on the coupling socket 23 via the securing limbs 30. An open position can correspond, for example, to a state in which the closure slide 29 is removed completely from the coupling socket 23 or is at least moved such that the securing limbs 30 are no longer in engagement with the securing groove 32. The movement from the securing position to the open position is possible only when the two securing limbs 30 are expanded such that the securing groove 32 can pass the constriction 38. However, this is in turn possible only when at the same time the coupling socket 23 and the attachment piece 16 are moved axially relative to each other along the coupling axis L2, specifically in such a way that the attachment piece 16 moves deeper into the coupling socket 23. During operation, the free-flowing medium is under pressure, and therefore the coupling socket 23 and the attachment piece 16 would be pressed apart from each other, which is prevented by the bearing via the securing limbs 30. A movement of the attachment piece 16 into the coupling socket 23 therefore takes place counter to the pressure forces that are present during operation. Therefore, the transfer of the closure slide 29 from the securing position to the open position during operation is not possible or is possible only with application of considerable force. In this way, a transfer of the closure slide 29 from the securing position to the open position, hence a release of the attachment piece 16 from the coupling socket 23, is prevented during operation. The higher the pressure of the free-flowing medium, the greater the force that has to be applied to the closure slide 29 in order to transfer the latter from the securing position to the open position. The higher the pressure that is present, the better the connection between the coupling connector 20 and the coupling socket 23 is secured against release. Even at a relatively low pressure of the free-flowing medium, the pressure forces that are present during operation have the effect that, upon manual movement of the closure slide 29, the two securing limbs 30 cannot be expanded so far that the closure slide 29 can be transferred to the open position in order to free the coupling connector 20 or release the attachment piece 16 from the coupling socket 23.

Preferably, in the securing position, the latching recess 37 is formed in the region of the securing groove 32.

### Aspect 2:

A plug coupling system according to aspect 1, wherein the respective latching recess (37) is in the form of a circle segment, wherein a radius of the respective circle segment corresponds to a radius of the securing groove (32).

The radius of the securing groove 32 is understood in particular as the radius of the groove bottom. By means of this design, it is possible to achieve a particularly good hold with little play, and also self-centering of the closure slide 29 with respect to the attachment piece 16.

### Aspect 3:

A plug coupling system according to either of aspects 1 and 2, wherein the securing limbs (30) and the through-openings (31) are dimensioned in such a way that, in the securing position, the securing limbs (30) are received with play in the through-opening (31).

It is thus possible to achieve, in a simple way, a freedom of movement of the securing limbs 30 into the through-openings 31 along the coupling axis L2 and a freedom of movement for the deflection of the securing limbs 30 away from each other in a direction perpendicular to the coupling axis L2.

### Aspect 4:

A plug coupling system according to one of aspects 1 to 3, wherein the respective securing limb (30) has a first end face (39) and the respective through-opening (31) is delimited by a first support face (40) of the coupling socket (23), wherein, in the securing position, the respective securing limb (30) bears with the first end face (39) on the first support face (40), wherein the first end face (39) and the first support face (40) each have an inclined or curved design.

In connection with the first end face 39 and the first support face 40, “inclined” is understood in particular as meaning that the respective face is inclined with respect to a reference plane, which reference plane is perpendicular to the coupling axis L2.

Support over as large a surface as possible can thus be achieved, wherein positive guidance can be achieved through the curvature and/or inclination, in such a way that the deflection of the securing limbs 30 away from each other causes a movement of the securing limbs 30 along the coupling axis L2 relative to the coupling socket 23 and, through the interaction of the securing limbs 30 with the attachment piece 16, the attachment piece 16 is moved along the coupling axis L2 into the coupling socket 23.

In principle, the first end face 39 and the first support face 40 can be designed in the form of an oblique plane relative to a reference plane perpendicular to the coupling axis L2.

Preferably, the respective first end face 39 complements the first support face 40 assigned to this first end face 39. In this way, these faces can bear on each other over as large a surface area as possible.

Preferably, the first end faces 39 are curved outward, hence convex, and the first support faces 40 are curved inward, hence concave.

### Aspect 5:

A plug coupling system according to aspect 4, wherein the first end faces (39) are designed in the shape of an arc of a circle with a first radius of curvature, and wherein the first support faces (40) are designed in the shape of an arc of a circle with a second radius of curvature, wherein a ratio of the first radius of curvature to the second radius of curvature is from about 95% to about 105%.

### Aspect 6:

A plug coupling system according to aspect 5, wherein the first radius of curvature and the second radius of curvature are identical.

It is thereby possible to achieve support across the greatest possible surface area, as a result of which load peaks are avoided.

### Aspect 7:

A plug coupling system according to one of aspects 1 to 6, wherein the respective through-opening (31) has a circular cross section.

Such a through-opening 31 can be produced in a simple way, for example by machining, in particular drilling, and a curved first support face is thus made available.

### Aspect 8:

A plug coupling system according to one of aspects 1 to 7, wherein the respective securing limb (30) has a second end face (41) with which the respective securing limb (30) bears on a second support face (42) circumferentially delimiting the securing groove (32), wherein the second end faces (41) and the second support faces (42) are in each case planar.

Load peaks can be avoided by means of the planar faces. Preferably, the second end faces (41) and the second support faces (42) are perpendicular to the coupling axis (L2). Thus, when the securing limbs (30) deflect away from each other, for example radially outwardly, the attachment piece (16) is prevented from moving along the coupling axis (L1) relative to the securing limbs (30). In this way, a movement of the attachment piece (16) in the coupling socket (23) along the coupling axis (L2) can be reliably effected upon deflection of the securing limbs (30) away from each other.

### Aspect 9:

A plug coupling system according to one of aspects 1 to 8, wherein the heated hose (3) has:
a flexible heated-hose body (6) having:
   a high-pressure hose (10), wherein the high-pressure hose (10) has a hose core, for the passage of the free-flowing medium, and a reinforcement surrounding the hose core,
   at least one heat conductor (13) for heating the medium flowing in the high-pressure hose (10),
   a thermal insulation layer (14) made of a thermally insulating material and surrounding the high-pressure hose (10) and the at least one heat conductor (13),
   an outer sleeve (15) surrounding the thermal insulation layer (14),
      wherein the heated hose (3) has the attachment piece (16), wherein the attachment piece (16) is connected to the high-pressure hose (10).

### Aspect 10:

A plug coupling system according to one of aspects 1 to 9, wherein the plug coupling system has an application head (2) for dispensing the free-flowing medium, wherein the heated hose (3) has the attachment piece (16) and the application head (2) has the coupling socket (23), wherein the application head (2) has a dosing valve (24), so that the free-flowing medium supplied to the application head (2) via the heated hose (3) can be selectively dispensed from a dispensing opening (25) of the application head (2), wherein the dosing valve (24) has a valve rod (26), wherein the valve rod (26) is displaceable, along a longitudinal axis (L3) of the valve rod (26), between a closed position, in which the valve rod (26) closes the dispensing opening (25) of the application head (2), and an open position, in which the valve rod (26) opens the dispensing opening (25) of the application head (2).

### Aspect 11:

A plug coupling system according to one of aspects 1 to 8, wherein the heated hose (3) has:
a flexible heated-hose body (6) having:
   a high-pressure hose (10), wherein the high-pressure hose (10) has a hose core, for the passage of the free-flowing medium, and a reinforcement surrounding the hose core,
   at least one heat conductor (13) for heating the medium flowing in the high-pressure hose (10),
   a thermal insulation layer (14) made of a thermally insulating material and surrounding the high-pressure hose (10) and the at least one heat conductor (13),
   an outer sleeve (15) surrounding the thermal insulation layer (14),
      wherein the heated hose (3) has the coupling socket (23), wherein the coupling socket (23) is connected to the high-pressure hose (10).

### Aspect 12:

A plug coupling system according to one of aspects 1 to 8 or 11, wherein the plug coupling system has an application head (2) for dispensing the free-flowing medium, wherein the heated hose (3) has the coupling socket (23) and the application head (2) has the attachment piece (16), wherein the application head (2) has a dosing valve (24), so that the free-flowing medium supplied to the application head (2) via the heated hose (3) can be selectively dispensed from a dispensing opening (25) of the application head (2), wherein the dosing valve (24) has a valve rod (26), wherein the valve rod (26) is displaceable, along a longitudinal axis (L3) of the valve rod (26), between a closed position, in which the valve rod (26) closes the dispensing opening (25) of the application head (2), and an open position, in which the valve rod (26) opens the dispensing opening (25) of the application head (2).

The plug coupling system can be used in the above-described heated hose and in the above-described application system.

### BRIEF DESCRIPTION OF THE DRAWING FIGURES

In the accompanying drawing figures, the present invention is explained in more detail on the basis of an exemplary embodiment, without being limited to the exemplary embodiment.

FIG. 1 shows a perspective view of an application system with an application head and a heated hose in a first configuration.

FIG. 2 shows the application system according to FIG. 1 in a side view.

FIG. 3 shows the application system according to FIG. 1 in longitudinal section.

FIG. 4 shows the heated hose in a view according to arrow IV in FIG. 5.

FIG. 5 shows the heated hose in a view according to arrow V in FIG. 6.

FIG. 6 shows the heated hose in a view according to arrow VI in FIG. 5.

FIG. 7 shows internal components of the heated hose in a perspective view.

FIG. 8 shows the heated hose in a longitudinal section.

FIG. 9 shows the heated hose in a cross section.

FIG. 10 shows the heated hose in an internal view.

FIG. 11 shows a heated-hose body in a longitudinal section.

FIG. 12 shows an attachment piece of the heated hose in a perspective view.

FIG. 13 shows the attachment piece in a sectional view.

FIG. 14 shows a side view of the application system according to FIG. 1 in a second configuration.

FIG. 15 shows a partial region from FIG. 3.

FIG. 16 shows the application system according to FIG. 1 in a cross section, with a closure slide in a securing position.

FIG. 17 shows the application system according to FIG. 1 in a cross section, with a closure slide in an open position.

FIG. 18 shows an attachment socket of the application head in a longitudinal section.

FIG. 19 shows a securing cap in a perspective view.

FIG. 20 shows a partial region from FIG. 15.

FIG. 21 shows the closure slide in a plan view.

### DETAILED DESCRIPTION OF EXEMPLARY EMBODIMENTS

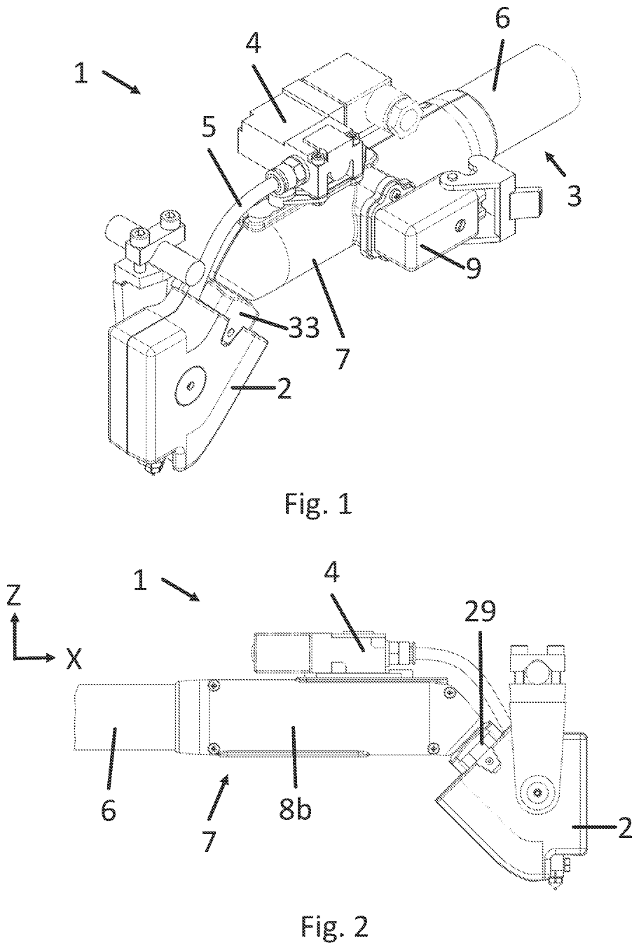

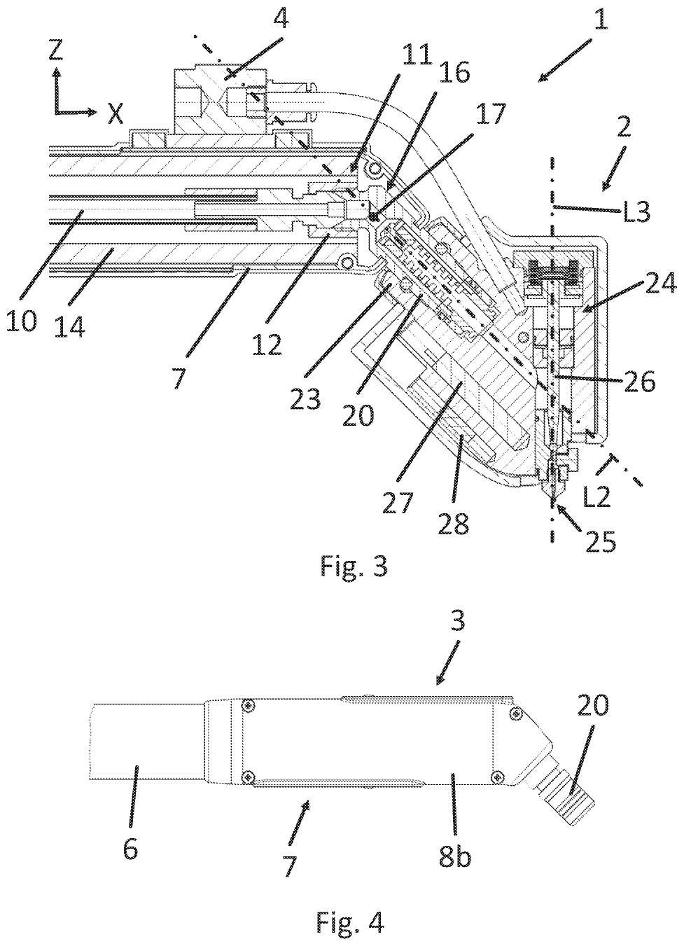

FIGS. 1 and 2 show an application system 1 for applying a hot-melt adhesive. The application system 1 has an application head 2. Moreover, the application system 1 has a heated hose 3, wherein the heated hose 3 is coupled to the application head 2. The heated hose 3 serves to deliver adhesive, which has been molten in a melter, to the application head 2. For this purpose, the heated hose 3 is coupled at its inlet end to the melter, hence fluidically connected, and is coupled at its outlet end to the application head 2, hence fluidically connected. The application head 2 has a dosing valve 24 (FIG. 3) such that the free-flowing medium delivered to the application head 2 via the heated hose 3 can be selectively dispensed from a dispensing opening 25 (FIG. 3) of the application head 2. The dosing valve 24 has a valve rod 26, wherein the valve rod 26 is displaceable, along a longitudinal axis L3 of the valve rod 26 (FIG. 3), between a closed position, in which the valve rod 26 closes the dispensing opening 25 of the application head 2, and an open position, in which the valve rod 26 opens the dispensing opening 25 of the application head 2. The dosing valve 24 is actuated by means of a pneumatically operated actuator, of which the piston is operatively connected to the valve rod 26. A solenoid valve 4 for switching compressed air is connected to the application head 2 via a hose 5. Depending on the switch position of the solenoid valve 4, compressed air is applied to the piston of the actuator and the dosing valve 24 is accordingly actuated.

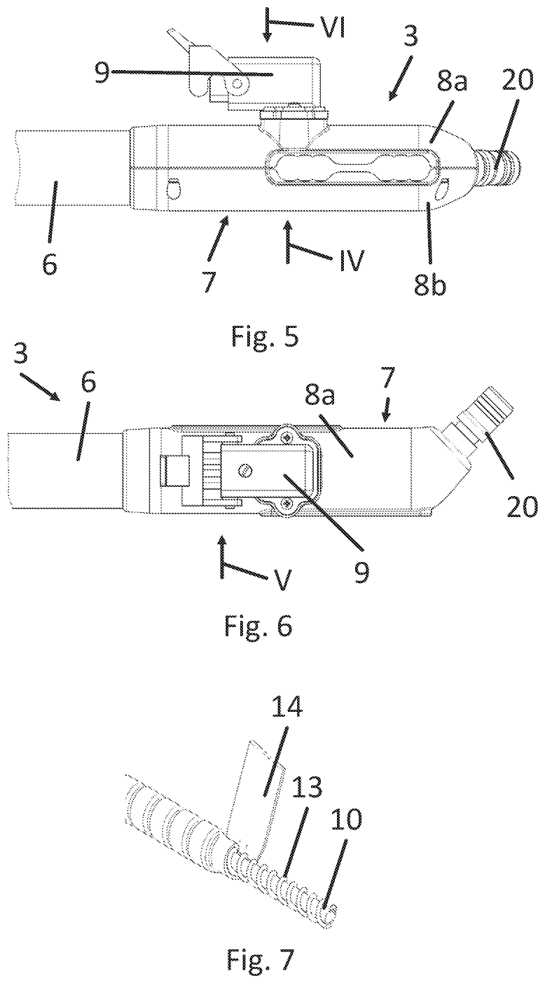

The heated hose 3 has a flexible heated-hose body 6, wherein the heated-hose body 6 is provided with a dimensionally stable end cap 7 in the region of an end portion directed toward the application head 2, wherein this end cap 7 in the present case is formed of two half-shells 8a, 8b (FIG. 5). The end cap 7 encloses the heated-hose body 6 all the way round in the circumferential direction and covers it at the front. The electrical lines of the heated-hose body 6, for example the connections for heat conductors 13 (FIG. 7) of the heated-hose body 6, are routed outward through the end cap 7, in the present case the half-shell 8a, and are wired to an attachment socket 9 mounted on the half-shell 8a. Moreover, control lines for external apparatuses, for example for the melter and/or the application head 2, can also be provided in the heated hose 3 and wired to the attachment socket 9. By way of the control lines and supply lines integrated in the heated hose 3, it is then also possible to establish electrical connections between the application head 2 and the melter. In the present case, the application head 2 is provided with a cable, which in turn is connected to a connection plug corresponding to the attachment socket 9. Cable and plug are not shown in the figures. This connection plug can be inserted into the attachment socket 9 of the heated hose 3 and, in this way, an electrical connection between the application head 2 and melter can be established via the heated hose 3. By way of this electrical connection between the application head 2 and the melter, a heating cartridge 27 (FIG. 3) is supplied with electrical energy from the application head 2. Moreover, by way of this connection, a temperature sensor 28 (FIG. 3) in the application head 2 is connected to the control device from the melter.

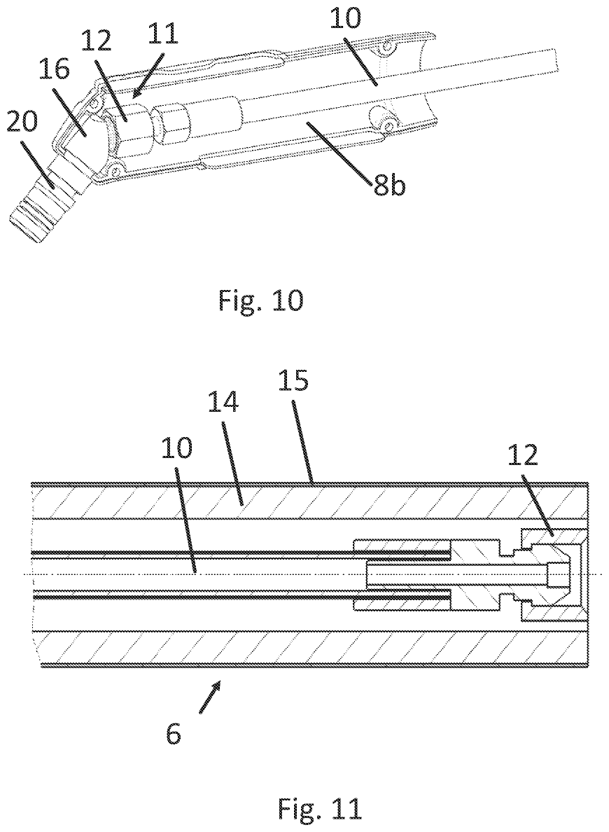

The heated-hose body 6 has a flexible high-pressure hose 10 (FIG. 3), wherein the high-pressure hose 10 has an inner hose core made of plastic for the passage of the free-flowing medium, and a reinforcement surrounding the hose core, for example in the form of a steel mesh, in order to achieve the necessary compressive strength. At its end, the high-pressure hose 10 has an attachment 11 (FIG. 3) in the form of a screw attachment 11 with union nut 12 (FIG. 3). The high-pressure hose 10 has heat conductors 13 wound around it in a helical shape, which heat conductors are shown only in FIG. 7; for reasons of clarity, they are not shown in FIG. 3 and FIGS. 8 to 11. Moreover, the heated-hose body 6 has a thermal insulation layer 14 (FIG. 3), wherein this thermal insulation layer 14 can be formed by an insulation band which is wound around the entire structure composed of high-pressure hose 10 and heat conductors 13, as is shown schematically in FIG. 7. Moreover, the heated-hose body 6 has a tubular outer sleeve 15 (FIG. 9, FIG. 11) forming the outermost layer of the heated-hose body 6 and made of a polyamide woven fabric.

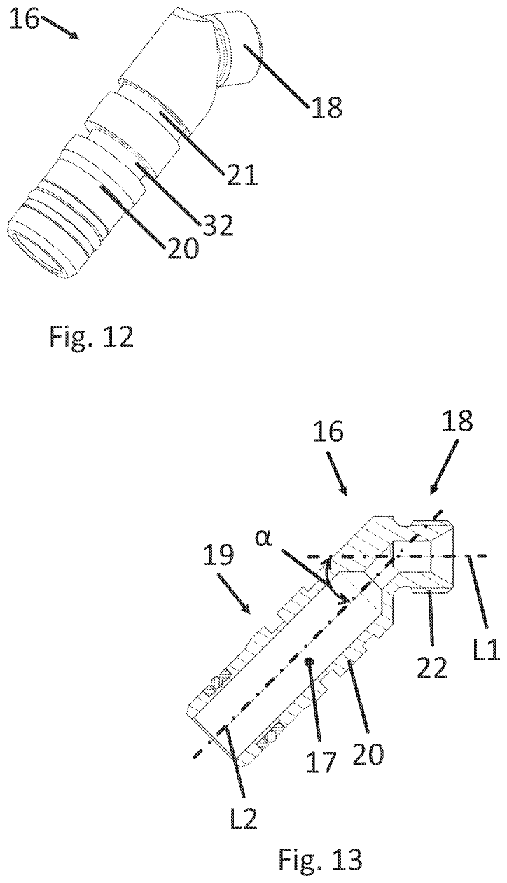

The heated-hose body 6 also has an attachment piece 16 (FIG. 3) connected to the high-pressure hose 10, wherein the attachment piece 16 has an angled design and has a through-channel 17 (FIG. 3) for the passage of the free-flowing medium through the attachment piece 16. The attachment piece 16 has a first limb 18 (FIG. 12, FIG. 13) with a first longitudinal axis L1 (FIG. 13) and, designed at an angle to the first limb 18, a second limb 19 (FIG. 13) with a second longitudinal axis L2 (FIG. 3). The first limb 18 and the second limb 19 enclose an angle α (FIG. 13) of about 45° in the present case.

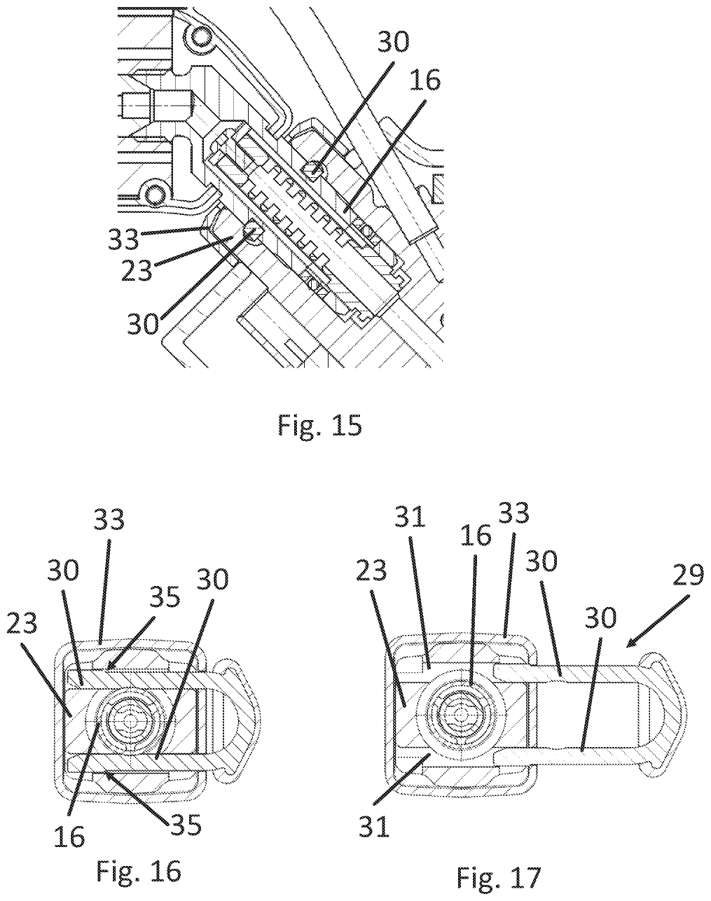

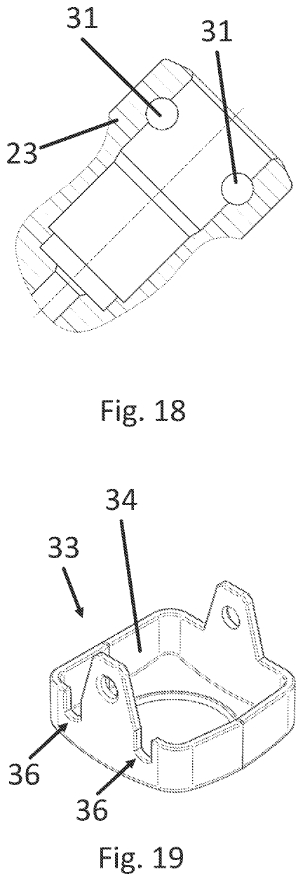

The first limb 18 has an outer thread 22 (FIG. 13) corresponding to the inner thread of the screw attachment 11 of the high-pressure hose 10. The attachment piece 16 is releasably connected to the high-pressure hose 10 by the union nut 12 being screwed onto the outer thread 22. The angled second limb 19 has a coupling connector 20 (FIGS. 3-6, FIG. 8, FIG. 10, FIG. 12, FIG. 13) in the form of a plug of a plug coupling. This coupling connector 20 serves to produce a fluidic connection between the heated hose 3 and the application head 2, by means of said coupling connector 20, designed as a plug, being coupled to, in the present case inserted into, a corresponding coupling socket 23 (FIG. 3, FIGS. 15-18) of the application head 2. In the present case, the coupling socket 23 is designed in the form of a stepped bore. The coupling connector 20 has a stepped external diameter corresponding thereto. The coupling connector 20 is inserted into the coupling socket 23 along a coupling axis L2 (FIG. 13) of the coupling connector 20, which in the present case is coincident with a longitudinal axis L2 of the second limb 19. The stepped diameters facilitate the coupling of the attachment piece 16 to the application head 2, since the stepped diameters provide a self-centering effect.

As can be seen in particular from FIG. 3, the region of the second limb 19 protruding from the end cap 7 is arranged almost completely in the application head 2. In this way, thermal losses in the transition region between the heated hose 3 and the application head 2 are reduced.

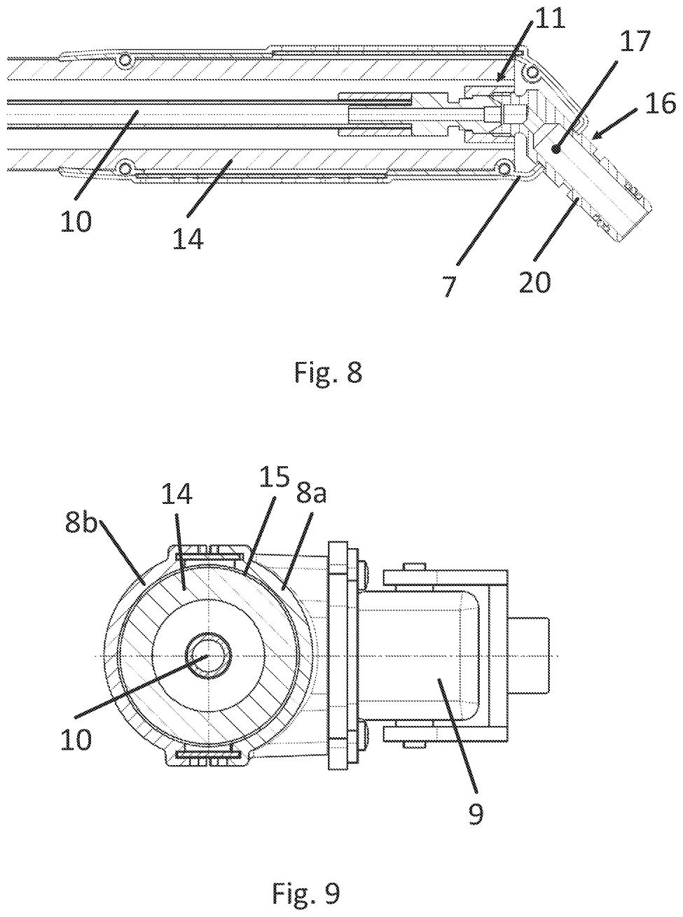

As can be seen in particular from FIG. 8, the second limb 19 is formed at least partially in a region enclosed by the end cap 7. The end cap 7 has an angled design corresponding to the angled attachment piece 16 and has a substantially hollow-cylindrical jacket portion and an angled cover portion. The jacket portion circumferentially encloses the first limb 18. The angled cover portion partially encloses the second limb 19, wherein the end cap 7 is in circumferential engagement with a groove 21 (FIG. 12) formed on an outer face of the second limb 19. The groove 21 is adjoined by the coupling connector 20, specifically in such a way that the latter protrudes from the end cap 7. The fact that the second limb 19 is formed partially inside the end cap 7 prevents the attachment piece 16 from turning about the longitudinal axis L1 of the first limb 18 with respect to the high-pressure hose 10. This prevents a release of the releasable screw connection between the attachment piece 16 and the high-pressure hose 10. With the end cap 7 fitted in place, the attachment piece 16 thus forms an integral constituent part of the heated hose 3, as a result of which a heated hose 3 is formed, in a simple way and without separate components, having a coupling connector 20 angled with respect to the axis of longitudinal extent of the heated hose 3 in the region of the end cap 7.

To obtain different outgoing directions of the heated hose 3 from the application head 2, the coupling connector 20 is rotatable in the coupling socket 23 about the coupling axis L2, in such a way that the heated hose 3 is rotatable about the coupling axis L2, at least in a state of the heated hose 3 free of pressure. In this way, by rotation of the heated hose 3 about the coupling axis L2, different outgoing directions of the heated hose 3 from the application head 2 can be achieved.

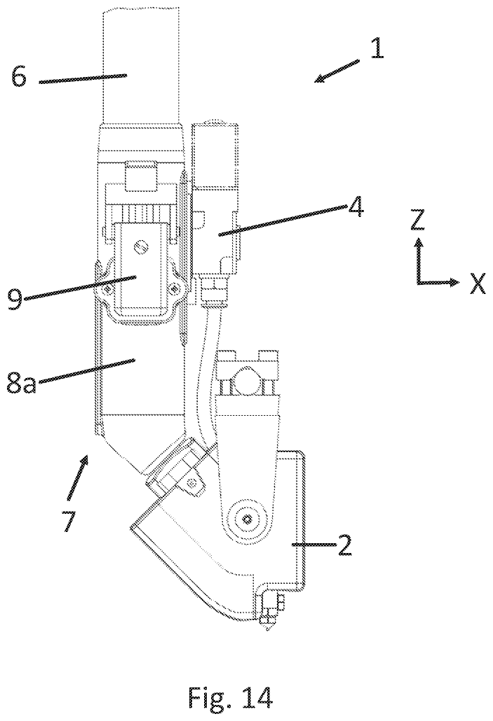

As can be seen in particular from FIG. 3, the coupling axis L2 and the longitudinal axis L3 of the valve rod 26 are angled relative to each other. The angled configuration corresponds to the angled configuration of the attachment piece 16, such that, in a first rotation position, the heated hose 3 issues from the application head 2 at an angle of about 90° to the longitudinal axis L3 of the valve rod 26 and, in a second rotation position, the heated hose 3 issues from the application head 2 at an angle of about 0° to the longitudinal axis L3 of the valve rod 26. Examples of these two different configurations or outgoing directions are shown in FIG. 2 and FIG. 14, respectively.

In the configuration shown in FIG. 2, the application head 2 is arranged in such a way that the glue is applied or output from the dispensing opening 25 counter to the vertical direction Z. The heated hose 3 is here rotated in such a way that it issues from the application head 2 at an angle of about 90° to the longitudinal axis L3 of the valve rod 26, i.e. issues in the horizontal direction X.

FIG. 14 shows the second configuration using the same components, namely the same heated hose 3 and the same application head 2, wherein the heated hose 3 is changed in terms of its outgoing direction relative to the application head 2. In FIG. 14, the application head 2 is again arranged in such a way that the glue is applied counter to the vertical direction Z. The heated hose 3 has been rotated through 180° about the coupling axis L2 compared to the configuration according to FIG. 2. In this way, the outgoing direction of the heated hose 3 is likewise changed, such that the heated hose 3 issues from the application head 2 at an angle of about 0° to the longitudinal axis L3 of the valve rod 26 and thus issues from the application head 2 in the vertical direction Z, instead of in the horizontal direction X. Furthermore, the arrangement of the solenoid valve 4 on the heated hose 3 has been changed.

As can be seen in particular from FIG. 16 and FIG. 17, the attachment piece 16, in the position coupled to the coupling socket 23, is secured in the coupling socket 23 via a displaceable closure slide 29. The closure slide 29 has two securing limbs 30, wherein the coupling socket 23 has two through-openings 31 for the insertion of the securing limbs 30, wherein the through-openings 31 run through the coupling socket 23 in such a way that the securing limbs 30 are insertable into the through-openings 31 from two opposite sides, wherein the attachment piece 16 has a circumferential securing groove 32 (FIG. 12) on its outer face, wherein the through-openings 31 are aligned with the securing groove 32 in the coupled position. To achieve a securing position of the closure slide 29, the securing limbs 30 are inserted through the through-openings 31 into the circumferential securing groove 32, as a result of which the attachment piece 16 is secured in the coupling socket 23 in the securing position. The securing position of the closure slide 29 is shown in FIG. 16 in a cross section. By contrast, FIG. 17 shows an open position of the closure slide 29 in which the securing limbs 30 and the securing groove 32 are disengaged. In this state, the attachment piece 16 can be withdrawn from the coupling socket 23.

The closure slide 29 is held captively in the coupling socket 23 via a securing cap 33 (FIG. 19) plugged onto the coupling socket 23, wherein the securing cap 33 has a cover portion, with an opening for the attachment piece 16, and a jacket portion 34 adjoining the cover portion, wherein the securing limbs 30 pass through the jacket portion 34, wherein a displacement of the closure slide 29 from the securing position (FIG. 16) and past an open position (FIG. 17), in which the securing limbs 30 and the securing groove 23 are disengaged, is prevented by the respective securing limb 30 having a stop 35 (FIG. 16) interacting with the jacket portion 34.

The securing cap 33 is designed in such a way that it can be plugged onto the coupling socket 23 and can be removed from the latter when the heated hose 3 is separated from the application head 2, hence when the attachment piece 16 is separated from the coupling socket 23. For this purpose, the jacket portion 34 has two notches 36 (FIG. 19), which are open in the direction of placement of the securing cap 33 and which serve to receive the securing limbs 30.

The heated hose 3 with the attachment piece 16, the coupling socket 23 and the closure slide 29 form a plug coupling system in which transfer of the closure slide 29 from the securing position (FIG. 16) to the open position (FIG. 17), with pressurized medium, is prevented or at least made difficult, as will be explained in detail below.

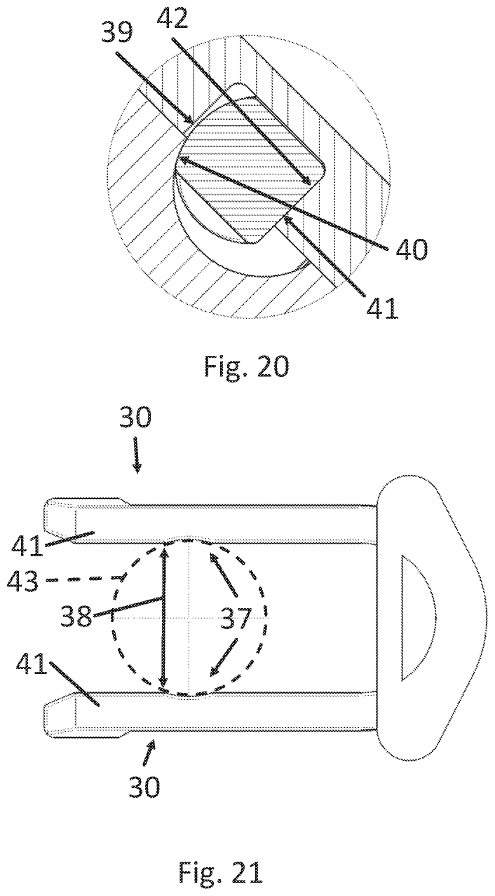

During operation, the free-flowing medium is under pressure, as a result of which the coupling socket 23 and the attachment piece 16 are pressed apart from each other. In the securing position, the closure slide 29 prevents the attachment piece 16 from being pushed out of the coupling socket 23, by virtue of the fact that the attachment piece 16 and the coupling socket 23 bear on each other along the coupling axis L2 via the securing limbs 30. In the present case, the respective securing limb 30 has a first end face 39 (FIG. 20) and the respective through-opening 31 is delimited by a first support face 40 (FIG. 20), wherein, in the securing position, the respective securing limb 30 bears with the first end face 39 on the respective first support face 40. The faces bearing on each other, i.e. first end face 39 and first support face 40, are designed complementing each other and thus bear on each other across the entire surface, as a result of which notch effects under loading are avoided, and therefore the material loads can be kept low. In the present case, the complementary design of the faces is such that the first end faces 39 are curved outward in the shape of an arc of a circle (convex) with a first radius of curvature, and the first support faces 40 are curved inward in the shape of an arc of a circle (concave) with a second radius of curvature, wherein the first radius of curvature and the second radius of curvature are almost identical. In the present case, the design of the first support faces 40 in the shape of an arc of a circle is achieved by the fact that the two through-openings 31 have a circular shape. The through-openings 31 can thus be easily produced by machining, for example drilling or milling.

To support the attachment piece 16, the respective securing limb 30 has a second end face 41 (FIG. 20) which lies opposite the first end face 39 in the direction of the coupling axis L2 and with which the respective securing limb 30 bears on a circumferential second support face 42 (FIG. 20) which delimits the securing groove 32 in the direction of the coupling axis L2. The second end faces 41 and the second support faces 42 are each planar and are oriented perpendicular to the coupling axis L1.

On its inner face directed toward the securing groove 32, the respective securing limb 30 has a latching recess 37 (FIG. 21) in the form of a circle segment, wherein the latching recesses 37 result in the formation, between the securing limbs 30, of a receiving region 43 (FIG. 21) which is adapted to the securing groove 32 and has a constriction 38 (FIG. 21). A clearance width of the constriction 38 is smaller than a diameter of the securing groove 32. To transfer the closure slide 29 from the securing position to the open position, and vice versa, the securing groove 32 has to overcome the constriction 38. To make this possible, the securing limbs 30 can deflect outward in order to widen the constriction 38 by application of force. When the closure slide 29 is transferred from the open position to the securing position, the two securing limbs 30, in order to overcome the constriction 38, are expanded slightly outward by the external diameter of the securing groove 32. To permit the deflection, the through-openings 31 are not completely filled by the closure slide 29, and therefore a sufficient free space is present in the radial direction, as can be seen from the detail of FIG. 15 shown in FIG. 20. After the securing groove 32 has passed the constriction 38, the securing limbs 30 deflect back to their initial position again, as a result of which the securing groove 32, in the securing position, is received with latching engagement in the receiving region 43. In the securing position, the centers and radii of the two circle segments of the latching recesses 37 are at least almost congruent with the center and the radius of the securing groove 32. In the securing position, the centers of the circle segments are likewise almost congruent with the coupling axis L2. In this way, the closure slide 29 is located in a defined position and cannot accidentally be moved away from the securing position by external influences during operation, for example by vibrations.

When the closure slide 29 is transferred from the securing position to the open position, the securing limbs 30 are expanded through interaction with the securing groove 32 and thus moved to a greater radius relative to the coupling axis L2. On account of the first end faces 39 and the first support faces 40 having the shape of an arc of a circle, the radially outward deflection or expansion of the securing limbs 30 forces a movement of the attachment piece 16 along the coupling axis L2 into the coupling socket 23. However, with free-flowing medium under pressure, movement into the coupling socket 23 takes place counter to the pressure forces caused by the medium and is therefore not possible or is possible only with application of considerable force. The higher the pressure of the free-flowing medium, the greater the force that has to be applied to the closure slide 29 in order to transfer the latter from the securing position to the open position. Even at a relatively low pressure of the free-flowing medium, the pressure forces caused by the medium have the effect that, upon manual movement of the closure slide 29, the two securing limbs 30 cannot be expanded so far that the closure slide 29 can be transferred to the open position. Therefore, on account of the aforementioned design, a transfer of the closure slide 29 from the securing position to the open position is prevented or at least made difficult when the medium is under pressure.

The first end faces 39 and the first support faces 40 can also be designed other than with a circular shape. Curved faces that are not circular are also conceivable, or planar faces with an inclination in the form of an oblique plane. It simply has to be ensured that a radially outward deflection of the securing limbs 30 causes an axial movement of the attachment piece 16 along the coupling axis L2 into the coupling socket 23, such that the attachment piece 16 would have to move deeper into the coupling socket 23, hence counter to the pressure forces when the free-flowing medium is under pressure.

That which is claimed is:

1-20. (canceled)

21. A heated hose for passage of a free-flowing medium, having:
a flexible heated-hose body having:
a high-pressure hose, wherein the high-pressure hose has a hose core, for the passage of the free-flowing medium, and a reinforcement surrounding the hose core;
at least one heat conductor for heating the medium passing in the high-pressure hose;
a thermal insulation layer made of a thermally insulating material and surrounding the high-pressure hose and the at least one heat conductor;
an outer sleeve surrounding the thermal insulation layer;
an attachment piece connected to the high-pressure hose, wherein the attachment piece has a through-channel, which allows the free-flowing medium to pass through the attachment piece, and a coupling connector for producing a fluidic connection between the heated hose and an external apparatus, by coupling the external apparatus along a coupling axis of the coupling connector;
an end cap, wherein the end cap covers an end portion of the flexible heated-hose body;
wherein the attachment piece is an angled attachment piece which has a first limb and, angled with respect to the first limb, a second limb, wherein the through-channel of the attachment piece runs through the first limb and the second limb to allow the free-flowing medium to pass through the attachment piece, wherein the first limb is connected to the high-pressure hose, wherein the second limb is formed at least partially in a region surrounded by the end cap, and wherein the coupling connector is formed in the region of the second limb.

22. The heated hose according to claim 21, wherein the coupling connector forms a constituent part of a plug coupling, and the plug coupling preferably has as constituent parts a plug and a socket, wherein the coupling connector forms the plug of the plug coupling.

23. The heated hose according to claim 21, wherein the coupling connector is arranged outside the end cap.

24. The heated hose according to claim 21, wherein the attachment piece is one piece.

25. The heated hose according to claim 21, wherein the connection between the first limb and the high-pressure hose is a screw connection, of which a screw axis of the screw connection corresponds to a longitudinal axis of the first limb.

26. The heated hose according to claim 21, wherein the end cap is in engagement with a groove formed on an outer face of the second limb.

27. The heated hose according to claim 21, wherein the end cap is angled corresponding to the angled attachment piece.

28. The heated hose according to claim 21, wherein the end cap has two half-shells.

29. The heated hose according to claim 21, wherein the thermal insulation layer encloses at least a partial region of the first limb.

30. The heated hose according to claim 21, wherein the through-channel of the attachment piece is formed by a first bore extending along a longitudinal axis of the first limb of the attachment piece and by a second bore extending along a longitudinal axis of the second limb of the attachment piece.

31. The heated hose according to claim 21, wherein an angle between the first limb and the second limb of the attachment piece is between about 40° and about 50°.

32. A method for producing a heated hose having the following method steps:
a) producing or providing a flexible heated-hose body of the heated hose, the flexible heated-hose body having:
a high-pressure hose, wherein the high-pressure hose has a hose core, for passage of a free-flowing medium, and a reinforcement surrounding the hose core;
at least one heat conductor for heating the medium passing in the high-pressure hose;
a thermal insulation layer made of a thermally insulating material and surrounding the high-pressure hose and the at least one heat conductor;
an outer sleeve surrounding the thermal insulation layer;
b) providing an angled attachment piece, wherein the attachment piece has a first limb and, angled with respect to the first limb, a second limb, wherein the attachment piece has a through-channel which runs through the first limb and the second limb to allow the free-flowing medium to pass through the attachment piece, wherein the first limb is releasably connectable to the high-pressure hose, wherein the second limb has a coupling connector for producing a fluidic connection between the heated hose and an external apparatus, by coupling the external apparatus along a coupling axis of the coupling connector;
c) producing the releasable connection between the high-pressure hose and the first limb of the attachment piece, wherein method step c) takes place after method steps a) and b);
d) arranging an end cap on an end portion of the heated-hose body in such a way that the end cap covers the end portion of the flexible heated-hose body, wherein the second limb of the attachment piece is formed at least partially in a region enclosed by the end cap, wherein method step d) takes place after method step c).

33. An application system having a heated hose according to claim 21 and having an application head for dispensing the free-flowing medium, wherein the application head has a coupling socket corresponding to the coupling connector, wherein the coupling connector and the coupling socket form a plug coupling, wherein the application head has a dosing valve so that the free-flowing medium supplied to the application head via the heated hose can be selectively dispensed from a dispensing opening of the application head, wherein the dosing valve has a valve rod, wherein the valve rod is displaceable along a longitudinal axis of the valve rod between a closed position, in which the valve rod closes the dispensing opening of the application head, and an open position, in which the valve rod opens the dispensing opening of the application head, wherein the coupling axis of the coupling connector and the longitudinal axis of the valve rod are angled relative to each other, wherein the coupling connector is rotatable in the coupling socket about the coupling axis of the coupling connector.

34. The application system according to claim 33, wherein the attachment piece, in a coupled position to the coupling socket, is secured in the coupling socket via a displaceable closure slide, wherein the closure slide has two securing limbs, wherein the coupling socket has two through-openings for the insertion of the securing limbs, wherein the through-openings run through the coupling socket in such a way that the securing limbs are insertable into the through-openings from two opposite sides, wherein the coupling connector has a circumferential securing groove on an outer face, wherein the through-openings are aligned with the securing groove in the coupled position, wherein, in a securing position of the closure slide, the securing limbs are inserted through the through-openings into the circumferential securing groove to secure the attachment piece in the coupling socket.

35. The application system according to claim 34, wherein the closure slide is held captively in the coupling socket via a securing cap that is plugged onto the coupling socket, wherein the securing cap has a cover portion, with an opening for the attachment piece, and a jacket portion adjoining the cover portion, wherein the securing limbs pass through the jacket portion, wherein a displacement of the closure slide from the securing position and past an open position, in which the securing limbs and the securing groove are disengaged, is prevented by the respective securing limb having a stop interacting with the jacket portion.

36. The application system according to claim 34, wherein the respective securing limb has a latching recess on an inner face directed toward the other securing limb, wherein the latching recesses result in a formation, between the securing limbs, of a receiving region which is adapted to the coupling connector and has a constriction, wherein the coupling connector overcomes the constriction by means of the securing limbs deflecting away from each other, wherein, in the securing position, the coupling connector is received in a latching engagement in the receiving region and the attachment piece and the coupling socket bear on each other along the coupling axis of the coupling connector, via the securing limbs, to secure the attachment piece in the coupling socket, wherein the through-openings and the securing limbs are configured such that, in the securing position, a deflection of the securing limbs away from each other causes a displacement of the attachment piece along the coupling axis of the coupling connector into the coupling socket.

37. A plug coupling system for producing a fluidic connection to a heated hose, wherein the plug coupling system has:
a heated hose for passage of a free-flowing medium, wherein the heated hose has an attachment piece for producing the fluidic connection to the heated hose, wherein the attachment piece has a through-channel, allowing the free-flowing medium to pass through the attachment piece, and a coupling connector, wherein the coupling connector has a circumferential securing groove on an outer face;
a coupling socket corresponding to the coupling connector, wherein the coupling connector and the coupling socket form a plug coupling, wherein the coupling connector is insertable into the coupling socket along a coupling axis of the coupling connector to produce a coupled arrangement;
a closure slide for securing the attachment piece in the coupling socket in the coupled arrangement, wherein the closure slide has two securing limbs, wherein the respective securing limb has a latching recess on an inner face directed toward the other securing limb, wherein the latching recesses result in a formation, between the securing limbs, of a receiving region which is adapted to the coupling connector and has a constriction, wherein the coupling connector overcomes the constriction by the securing limbs deflecting away from each other, wherein the coupling socket has two through-openings for the securing limbs, wherein the through-openings are aligned with the securing groove in the coupled arrangement, such that, in the coupled arrangement, the securing limbs are insertable through the through-openings into the circumferential securing groove to produce a securing position, wherein, in the securing position, the coupling connector is received in a latching engagement in the receiving region and the attachment piece and the coupling socket bear on each other along the coupling axis of the coupling connector, via the securing limbs to secure the attachment piece in the coupling socket, wherein the through-openings and the securing limbs are configured such that, in the securing position, a deflection of the securing limbs away from each other causes a displacement of the attachment piece along the coupling axis of the coupling connector into the coupling socket.

38. The plug coupling system according to claim 37, wherein the respective securing limb has a first end face and the respective through-opening is delimited by a first support face of the coupling socket, wherein, in the securing position, the respective securing limb bears with the first end face on the first support face, wherein the respective first end face is configured to complement the respective first support face, wherein the respective first end face is curved outward and the respective first support face is curved inward, wherein the respective first end face is in the shape of an arc of a circle with a first radius of curvature, and wherein the respective first support face is in the shape of an arc of a circle with a second radius of curvature, wherein a ratio of the first radius of curvature to the second radius of curvature is from about 95% to about 105%.

39. The plug coupling system according to claim 38, wherein the first radius of curvature and the second radius of curvature are identical.
